(19) United States
(12) Patent Application Publication
(10) Pub. No.: US 2010/0063845 A1
(43) Pub. Date: Mar. 11, 2010

(54) Systems and Methods for Allowing Patient Access to a Patient Electronic Health Records

(75) Inventors: Vijaykalyan Yeluri, Sunnyvale, CA (US); Denny Lau, Emeryville, CA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 12/207,990

(22) Filed: Sep. 10, 2008

(51) Int. Cl. G06Q 50/00

(52) U.S. Cl. 705/3; 705/2

(57) ABSTRACT

Methods and systems are provided for providing patient and healthcare providers with access to a patient EHR a computer workstation. A user interface accessible via a network is provided that allows a user to access an EHR system comprising at least one patient EHR. The user is identified using a security administrator, and access is granted and denied based on user identification. The user obtains a patient EHR from the EHR system by providing instructions via the user interface. The user is provided with at least one functionality application allowing a user to add information to the patient EHR. The patient EHR is updated based upon the information entered by the user using the at least one functionality application and storing the updated patient EHR in the EHR database.

### BACKGROUND OF THE INVENTION

Certain embodiments of the present technology relate to recording a patient encounter with a healthcare provider. More specifically, certain embodiments relate to capturing the events occurring during a patient encounter, and monitoring a patient's health and activity between visits.

Healthcare providers, such as physicians, create large volumes of patient information during the course of their business at healthcare facilities, such as hospitals, clinics, laboratories and medical offices. For example, when a patient visits a physician for the first time, the physician generally creates a patient file including the patient's medical history, current treatments, medications, insurance and other pertinent information. This file generally includes the results of patient visits, including laboratory test results, the physician's diagnosis, medications prescribed and treatments administered. During the course of the patient relationship, the physician supplements the file to update the patient's medical history. When the physician refers a patient for treatment, tests or consultation, the referred physician, hospital, clinic or laboratory typically creates and updates similar files for the patient. These files may also include the patient's billing, payment and scheduling records.

When a patient comes into a health care facility, the patient may have numerous related or unrelated problems that the healthcare provider will have to sort through when determining what is wrong with the patient and what treatments should be prescribed for the patient. Manually reviewing the chart for previous clinical findings relevant to the current problems can be a very time consuming and error-prone procedure. The diagnostic step in the treatment of the patient can thus be a very difficult process and arguably the most important step in treating a patient. Unfortunately, all of the needed materials may not be available during the examination of the patient and thus important questions may not be asked or tests performed which could help the healthcare professional in determining the correct diagnosis for the problems being experienced by the patient.

Many medical providers have access to systems that offer a patient Electronic Health Records (“EHR”, or Electronic Medical Record “EMR”). An EHR that captures information pertaining to patient encounters with a medical provider as well as other information about the patient's health and treatment history. In anticipation of a patient visit, or during an encounter, a medical provider may access a patient's EHR to review prior prescriptions prescribed to the patient, patient allergies or patients family health history, for example.

Presently, however, there are no systems or methods available that provides patients with access to their own EHR. Such a system and/or method would be useful to offer patients access to their previous encounters with their medical providers, view their medical advice, prescriptions and diagnoses, and access physician instructions. There thus exists a need for providing patients with a system and method allowing electronic access to their medical health records.

### BRIEF SUMMARY OF THE INVENTION

Certain embodiments present a network for providing patient access to patient EHRs. The network has an EHR system for creating and storing patient EHRs, each patient EHR being associated with one patient. The EHR system comprises an encounter capture system for capturing information gathered during a patient visit to a healthcare provider and recording the information in a patient EHR, and an EHR database for storing at least one patient EHR. In certain embodiments, the encounter capture system has an encounter capture application that records the dialogue of patient encounters with a healthcare provider. The network also comprises a network hub electronically connecting the EHR system with at least one computer workstation. In certain embodiments, the network comprises a user interface providing interactive access to patient EHRs stored in the EHR system. The network also has at least one functionality application allowing a user, through the user interface, to interactively add information to at least one patient EHR. A patient connected to the network through the network hub may access the patient EHR associated with the patient from a computer workstation via the user interface. The user may also add information to the patient EHR through the functionality application or applications.

Certain embodiments provide an EHR system for capturing, storing and providing access to at least one patient EHR. In certain embodiments, the EHR system comprises an encounter capture system for capturing information gathered during a patient visit to a healthcare provider and recording the information in a patient EHR, and an EHR database for storing at least one patient EHR. The EHR system also has a user interface enabling interactive access to the EHR database via a computer workstation, and at least one functionality application operable by a user via a the user interface. In certain embodiments the EHR system comprises a security administrator restricting and allowing access to the EHR database from a computer workstation, the security administrator requiring an input from a user via the user interface. The user interface operates the at least one functionality applications on user instruction, and the functionality application or applications provide function for modifying at least one patient EHR in the EHR database.

Certain embodiments of the presently described technology provide a method for providing patient and healthcare provider access to a patient EHR a computer workstation. The method provides a user interface accessible via the internet that allows a user to access an EHR system comprising at least one patient EHR. Next, the method prompts a user for user identification. Next, the method obtains a patient EHR from the EHR system when instructed by a user via the user interface. Next, the user is provided with at least one functionality application allowing a user to add information to the patient EHR. The method updates the patient EHR based upon the information entered by the user using the at least one functionality application and storing the updated patient EHR in the EHR database.

### BRIEF DESCRIPTION OF SEVERAL VIEWS OF THE DRAWINGS

FIG. 1 illustrates a block diagram of an EHR system in accordance with certain embodiments of the presently described technology.

FIG. 2 illustrates a block diagram of a network incorporating an EHR system in accordance with certain embodiments of the presently described technology.

FIG. 3 illustrates a block diagram of an EHR system having a user interface in accordance with certain embodiments of the presently described technology.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Preliminarily, it should be noted that, while a particular system and method is described in detail herein for analyzing medical imaging data, such as radiology data, this is not by way of limitation, but solely for the purposes of illustration, and the invention may also be employed for analyzing data of other types. It shall also be noted that the use of the term “patient” throughout this description and the claims refers to a patient of a healthcare provider, or one acting on behalf of the healthcare provider, including but not limited to the members of the patient's family, the primary caretaker of the patient, or another party acting on the patient's behalf. It should also be noted that the term “healthcare provider” includes any person or persons responsible for providing healthcare to a patient, including but not limited to the patient's physician and/or doctor, surgeons, radiologists, nurses, or other medical or clinical staff members.

To provide proper healthcare to a patient, the care should be seamless and continuous. Typically, a patient is only provided with proper healthcare during visits to a healthcare provide, be it through routine office visits, emergency hospital stays or the like. While this visit to visit care can provide patients with care and guidance during the visits, the disjointed nature of the contact between healthcare provider and patient can lead to problems such as patient confusion about treatment, patient straying from physician recommended activity and lack of physician knowledge of a patient's day to day activity.

Healthcare providers create and maintain a patient health record for each patient. Often times the patient health record comprises as much information about the patient's health and health history as is known. For example, the patient health record may provide a listing of every patient encounter with a healthcare provider with a summary of the details of the encounter. The patient health record may also have information pertaining to the patient's allergies, family health history, disabilities, as well as the history of the patient's blood pressure, cholesterol level, height and weight, medication history, clinical visits, lab tests, radiology exams, pathology exams, genetic tests, immunology tests, vaccinations and prescriptions, for example.

Many medical providers have access to systems that offer a patient Electronic Health Records (“EHR”, or Electronic Medical Record “EMR”) that captures information pertaining to patient encounters with a medical provider as well as other information about the patient's health and treatment history. In anticipation of a patient visit, or during an encounter, a medical provider may access a patient's EHR to review prior prescriptions prescribed to the patient, patient allergies or patients family health history, for example.

An EHR maintains a patient's health record electronically, so that the record may be accessed and modified from a computer workstation. The use of electronic health records is convenient in that the records do not need to take up space as a physical file, they may be modified, adjusted, corrected or added to easily from a number of computer work stations. The EHR can also provide access to applications that assist healthcare providers in making diagnoses and treatment decisions, for example, by displaying a patient's blood pressure levels over the course of time. The EHR can also provide access to records of previous surgical procedures, helping a physician understand why the patient's anatomy may be abnormal.

The presently described technology improves on the present use of patient EHR keeping and review by providing systems and methods that offer access to the EHR by patients and other users. Providing patient access to an EHR offers the ability to have a continuous stream of communication and data transfer between the patient and the healthcare provider. A patient accessible EHR provides a patient with continuous access to the patient's treatment, medical advice, prescription doses, dietary and other controlled physician recommendations and information pertaining to upcoming physician office visits. The present technology also provides an extension of a healthcare visit such that there is a way for the healthcare providers to monitor a patient's daily activity between visits.

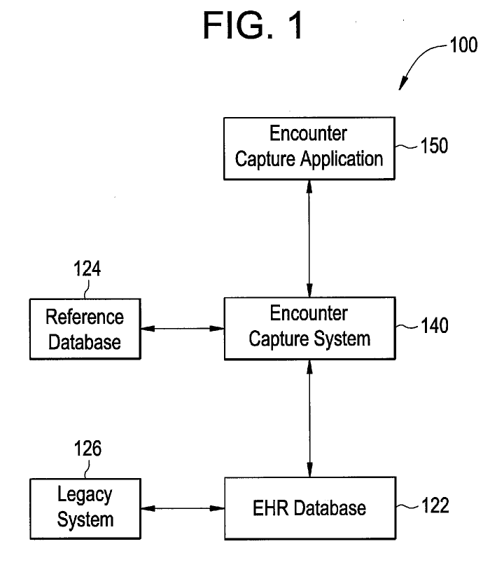

FIG. 1 illustrates a block diagram of an exemplary EHR system 10. Healthcare providers, such as physicians, at hospitals, laboratories and clinics, generally capture and access patient data using an encounter capture system 140 that communicates with an EHR database 122. Patient data, such as vital signs, x-ray images and laboratory results, resides in the EHR database 122 in the form of patient EHRs. The encounter capture system 140 may also communicates with external sources to obtain patient data, such as laboratory test results and x-ray images, and to transfer patient information, such as prescriptions for medication, from the EHR system 10 to other healthcare providers.

In certain embodiments, the encounter capture system 140 may communicate with, or comprise an encounter capture application 150 that records or otherwise preserves information pertaining to a patient's encounters or visits to a healthcare provider. Occasionally, information passed from a healthcare provider to a patient can go unrecorded or forgotten, even when patient encounters are recorded electronically. Accordingly, the encounter capture application 150 records and/or transcribes the activity happening during a patient encounter. For example, in certain embodiments, the automatic capture tool has an audio and/or video recorder that can record audio and video sessions of patient visits, and allow the encounter capture system 140 to update the patient EHR accordingly.

In certain embodiments of the preset technology, the encounter capture application 150 transcribes the dialogue between the healthcare provider and patient using speech a recognition tool. The encounter capture system 140 can then assemble the dialogue into a readable format that may be accessible on the EHR system. Thus, patients, physicians or other interested parties can review the encounters thereby removing any problems from lost or forgotten treatments.

The encounter capture system 140 captures patient data in real-time at the point of care, that is, where healthcare providers interact with their patients. For example, physicians can use an encounter capture system 140 to enter, access, process, analyze and annotate data from patient records in real-time at the point of care. Thus, using the encounter capture system 140, a physician, who has many patients in a hospital, can visit each patient in their room, access their EHR there, enter results of the current examination, evaluate their medical history, electronically annotate their x-rays images and prescribe medications and treatments instantaneously as the encounter capture system 140 captures and organizes patient data into the patient EHR. The encounter capture system 140 may likewise communicate with a reference database 124 to assist a healthcare provider in making diagnoses, prescribing medications and administering treatments. Moreover, the EHR database 122 may also communicate with a legacy data system to access pertinent patient data in paper files and mainframe electronic databases.

Typically, the encounter capture system 140 is a point of care system that captures the significant data and/or information pertaining to a patient visit, or patient encounter with a healthcare provider. For example, the encounter capture system may be a computer workstation where healthcare professionals enter information and/or data pertaining to a patient encounter. In certain embodiments, however, the encounter capture system 140 can be an application accessible via workstation that is in a location not at the point of care. For example, a physician may record significant patient data and/or information at the point of care using a notebook, and then enter the information into the encounter capture system 140 at a workstation in the physician's office, where

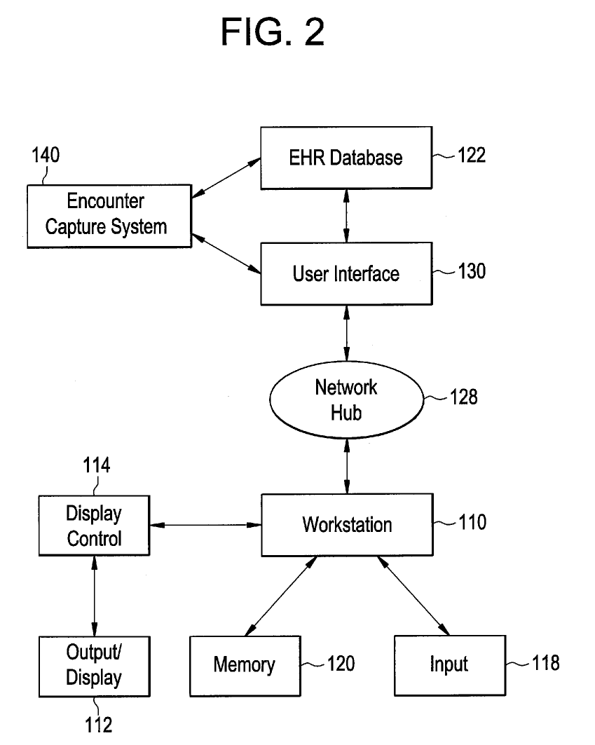

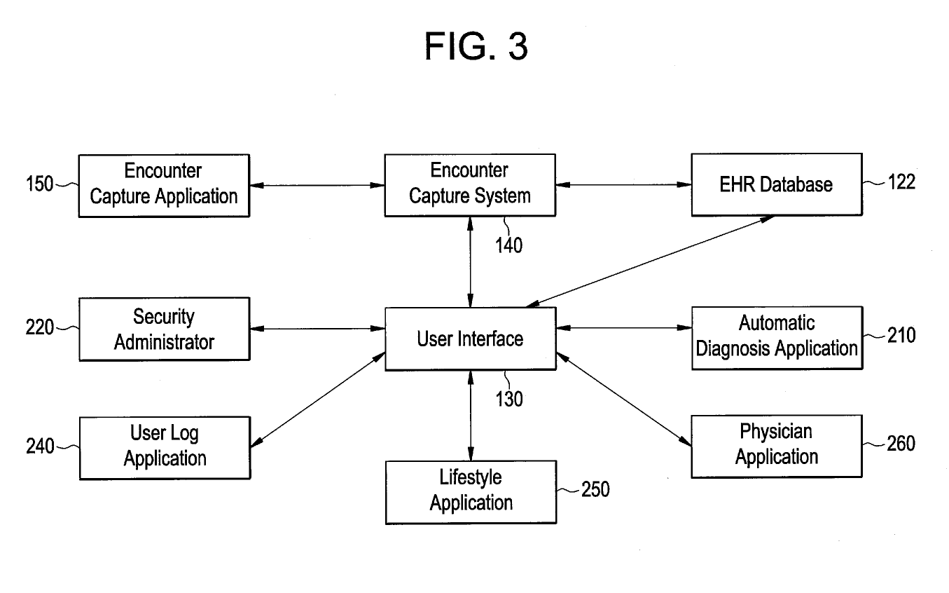

FIG. 2 illustrates network 200 allowing user access to an EHR system 100 via a user interface 130. In certain embodiments, EHR system 100 may be in the embodiment of EHR system 10 of FIG. 1, the EHR system 300 of FIG. 3, or a number of other EHR system embodiments. The network 200 has at least one workstation 116, which may be a processor or a computer. The workstation 116 has one or more input devices 118 such as a keyboard or a mouse. The workstation 116 also has a database file or memory 120 such as a hard drive or other storage mechanism. The workstation 116 operates a standard display controller 114 which in turn, controls a display device 112 at the workstation 116. The display device 112 can be any standard type of display monitor, attached or wireless.

The workstation 116 connects to the network 200 via a network hub 128. The network hub 128 provides access from a workstation 116 to the EHR system 100 that has information pertaining to one or more specific patient electronic health records. In certain embodiments, the network hub 128 is an internet gateway such as a web page. The network hub 128 may restrict and grant access to users based on a user login. For example, where the network hub 128 is an internet page gateway, the page may prompt users connecting to the site via a workstation such as workstation 116 for a user name and password. In certain embodiments, the network hub 128 may restrict access to the EHR system 100 based on the workstation that is attempting to gain access to the network 200. For example, the network hub 128 may only grant access to the EHR system 100 if the user is attempting to access the network 200 through a computer registered to a licensed medical practitioner, or in use at a particular healthcare office or clinic.

In certain embodiments, the network 200 may comprise several workstations 116. Indeed, where the system provides access to the EHR system 100 via the internet, there may be numerous workstations 116 connected to the network 200 at a given time.

Once connected to the network 200, the user interacts with the EHR system 100 via a user interface 130. The interface 130 provides the user with interactive access to an EHR database 122 which contains information pertaining to the patient EHRs. The EHR database 122 may have information pertaining to a plurality of patient EHRs. A user may access a particular patient EHR by logging in using a user name and password, or by some other means, such as selecting a patient name from a list of potential patient names, by providing patient information such as phone number or social security number or any other means. The user interface scrolls the EHR database 122 and obtains the patient EHR allowing the user to view all of its contents via the workstation 116.

A patient EHR can be created and maintained using a variety of methods. Furthermore, a patient EHR may comprise a variety of data and information, typically the information pertaining to medical findings and suggestions. FIG. 3 illustrates a block diagram of an EHR system 300 comprising a plurality of functionality applications provided by user interface 130. The functionality applications allow for a user, such as a patient or a healthcare provider add, delete, update, modify and otherwise maintain patient EHRs stored within the EHR database 122 through the records EHR system 300.

In certain embodiments, the descriptions of the medical findings can be provided by an automatic diagnosis application 210. The automatic diagnosis application 210 stores medical findings that can be presented to a user via the user interface 130. Medical findings can be symptoms, history, physical findings, diagnoses, tests, treatment options, physician suggestions (e.g., dietary rules, instructions to monitor blood pressure, exercise regimens, plan to reduce smoking, etc.) and therapy which may be present for a particular patient. The medical findings may be divided into categories such as symptoms, history, physical findings, diagnoses, tests, and therapy. These findings may be accessible to a user accessing the EHR system 300 via the user interface 130 by use of pull down menus or other interactive selection methods. Based upon information entered into the EHR system 300 via the user interface 130, the automatic diagnosis application 210 can provide the user with appropriate medical findings.

In certain embodiments, the automatic diagnosis application 210 may have medical findings stored in the patient EHR in a hierarchical manner, having, for example, eight levels of description. For example, the first level gives the simplest explanation of a medical finding, for example, a cough. The explanations become more detailed the lower the level. As noted above, a first level finding may be a cough, while a second level finding may be a brassy cough. In certain embodiments, the automatic diagnosis application 210 has all of the medical findings are coded so as to be distinct from each other. For example, each medical finding can be assigned an internal number which uniquely identifies that particular medical finding. In addition, each medical finding also contains a code which indicates which category within the patient EHR the medical finding is associated with. For example, a medical finding may contain the code SYM to indicate that the medical finding is associated with the symptom section; HIS to indicate that the medical finding is associated with the history section; PHY to indicate that the medical finding is associated with the physical section; DIS to indicate that the medical finding is associated with the diagnoses section; TST to indicate that the medical finding is associated with the test section; and RX to indicate that the medical finding is associated with the therapy section.

The automatic diagnosis application 210 provides a detailed description of the diagnoses using the medical finding terms which are stored in patient EHRs. For example, for each diagnosis, the medical finding associated with the diagnosis is assigned a numerical value depending on how important such a medical finding may be to the diagnosis. For example, in the detailed description of the diagnosis for coronary artery stenosis, medical findings such as chest pain or discomfort and dyspnea (shortness of breath), which are strong showings of coronary artery stenosis, will be given high values while a lack of a desire for food may not be described in the diagnoses at all or given a very low value.

The detailed description of the diagnoses stored in the automatic diagnosis application 210 contains lists of symptoms as well as personal and family history and physical findings which a patient should or may have experienced. In addition, the detailed diagnoses contain lists of tests, possible therapies, and medications which should be prescribed for the patient if the healthcare professional decides that the patient is experiencing a particular illness or problem.

In certain embodiments of the present technology, the automatic diagnosis application assigns medical findings values between 1 and 20 wherein the value 20 indicates the most important medical finding, however the invention is not limited thereto. Thus, the values assigned to each medical finding within the detailed description are proportional to how important such a medical finding is to the diagnosis. Furthermore, the values can vary for a given medical finding depending on a plurality of factors such as age of the patient and timeframe, i.e., when a symptom occurred in relation to other symptoms. For example, a white blood cell count of 18,000 may be given a high value if the patient is an adult while the same medical finding is not given a value at all if the patient is a new-born child because this is normal for a new-born child.

A security administrator 220 manages access to the EHR system 300. In certain embodiments of the present technology, more than one user has access to a patient EHR. For example, not only can the patient and the patient's family and/or caretakers access the patient EHR away from the healthcare facility, but the healthcare providers can monitor the patient's EHR from a computer workstation 116 by logging into the EHR system 300 through the security administrator 220. Furthermore, where the EHR system is accessible on the internet, the security administrator 220 allows for users to access the system from any computer workstation by providing specific user account identification. In certain embodiments, user identification may identify the user's name, user account, and type of user, such as patient or healthcare provider, for example. The user identification may be obtained by the security administrator 220 by prompting a user for a user name and password, for example, via the user interface.

The automated diagnosis generator described above can be verified, modified, added to or deleted by a practitioner based upon whether the output generated by the diagnosis generator agrees with or conflicts with the views of the practitioner. The healthcare provider can access the patient EHR and modify the patient EHR accordingly, for example, through a physician application 260 via the user interface 130. Additionally, the healthcare provider may only wish to monitor the patient EHR to ensure that the proper instructions have been followed. For example, a patient having high blood pressure problems may have been given a restricted diet by the healthcare provider, instructing the patient to limit the amount of cholesterol consumed. The healthcare provider can instruct the patient to update the patient EHR with a dietary log that lists the food the patient has consumed over the course of a period of time. Where the healthcare provider notices that the patient has strayed from the instructions, the provider may contact the patient or arrange for an office visit to discuss the matter.

FIG. 3 also depicts an encounter capture application 150. The encounter capture application 150 records or otherwise preserves information pertaining to a patient's encounters or visits to a healthcare provider. Occasionally, information passed from a healthcare provider to a patient can go unrecorded or forgotten, even when patient encounters are recorded electronically. Accordingly, the encounter capture application 150 records and/or transcribes the activity happening during a patient encounter. For example, in certain embodiments, the automatic capture tool has an audio and/or video recorder that can record audio and video sessions of patient visits and place them in the patient EHR.

In certain embodiments of the preset technology, the encounter capture application 150 transcribes the dialogue between the healthcare provider and patient using speech a recognition tool. The encounter capture application 150 can then assemble the dialogue into a readable format that may be accessible on the EHR system. Thus, patients, physicians or other interested parties can review the encounters thereby removing any problems from lost or forgotten treatments.

In certain embodiments, users of the EHR system may be identified by certain titles. For example, users may be identified as a patient or a healthcare provider. Those identified as patients may include the patient, family and/or caretakers of the patient. Those identified as healthcare providers may include the physician/doctor, nurse, or other employees in the healthcare environment. The security administrator 220 can allow or restrict access to the EHR system, or to particular functionality applications based on the user's identification, which can be authenticated via a user name and password. For example, the security administrator 220 may only allow those parties identified as patients to access functionality applications such as the lifestyle application and/or the user log application. Additionally, the security administrator can restrict access to functionality applications like the physician application to only healthcare providers, or even further, to particular healthcare providers such as the primary physician alone.

In certain embodiments, the user interface 130 is presented to a user accessing the EHR system 300 via an interactive webpage. The interface 130 may offer a variety of applications for use by a patient accessing the EHR system 300. The user may access the applications, for example, by clicking a mouse button on an icon or a pull-down menu, or by entering a command using a keyboard. For example, the user may elect to view the transcript from a previous encounter, to view daily dietary suggestions, to review lifestyle suggestions or to enter information. These functions may be provided to the user via other applications that work with the user interface 130. For example, in certain embodiments, the user may be able to enter and maintain a log, or journal that allows the user to repeatedly enter information via a user log application 240. In certain embodiments the user log application 240 may accept input from a user pertaining to the user's cholesterol intake. Each day the user may enter the foods that the user has consumed, and the log can record the input for future review by the patient, a physician or another user.

In certain embodiments, the user interface provides the user with a lifestyle application 250. The lifestyle application may provide assistance to patients and users that have physician recommended lifestyle guidelines. The lifestyle application prompts a user for patient lifestyle information. For example, the lifestyle application 250 may prompt the user for information pertaining to: the number of cigarettes smoked in a given time frame, the total calories burnt from exercise, the estimated calories consumed in a time frame, the total cholesterol consumed in a time frame, the patient's resting heart rate or blood pressure, the patient's weight, the patient's temperature, the number of hours slept by the patient and other information that may be helpful to assist a healthcare provider in providing treatment. The lifestyle application 250 may operate together with the user log application 240 to continually update and modify the patient EHR based on user input and feedback.

In certain embodiments the lifestyle application 250 and/or the user log application 240 may utilize a dietary assistance tool 255 that calculates the number of calories, amount of cholesterol, sodium or other dietary information based upon the information entered by the user. For example, the lifestyle application 250 may provide the user with an option to enter breakfast information. In the breakfast information application, the user may select from a series of foods, and enter the quantity of food consumed. For example, the user may select “eggs” from the interface and enter the quantity of eggs consumed. The dietary assistance tool 255 may then calculate the quantity of calories consumed in the meal based on the information provided by the user.

The patient's healthcare provider may continually monitor the patient's EHR as it is being added to and/or modified by the patient through the physician application 260 which can be accessed via the user interface 130. In turn, the healthcare provider can provide further treatment or advice to the patient through the EHR system. The patient may access the healthcare provider treatment or advice through an option on the user interface. For example, after logging in, a user may be presented with an option to view “new physician treatment” similar to an email inbox, where the user can access the comments, advice, treatment or other information provided by a healthcare provider.

Additionally, the healthcare provider can use the physician application 260 to provide questions for the patient or user to answer via the EHR system interface. For example, the healthcare provider may discover, via the user inputted information through applications such as the user log application 240 or the lifestyle application 250, that the patient has reduced his or her caloric intake consistently for several weeks. The discovery of this information may cause the provider to prompt the user to enter the patient's current weight and/or blood pressure, for example. As a further example, a physician, after prescribing a patient with some medications for diabetes, may request information to track the patient's blood glucose level trend to ensure that the patient is adhering to the care guidelines and responding to the medication in an expected manner.

An example of operation of the EHR system 300 is provided as follows. A patient having a particular disorder may require monthly visit with a physician. During each monthly visit, the healthcare provider accesses the patient's present EHR from an EHR database 122. The healthcare provider also sets up the encounter capture application 150, so that information can be recorded during the patient visit. For example, the encounter capture application 150 may use voice recognition software to create a transcript of the dialogue between the healthcare providers and the patient, or any other attendees to the visit. Alternatively, the encounter capture application 150 may simply provide an interface where a user, such as a healthcare provider, can enter notes or a summary of the visit. In certain embodiments, the encounter capture application 150 records audio and/or video of the visit. The encounter capture application 150 then adds the information about the encounter to the patient's EHR and stores the newly updated EHR in the EHR database 122.

Between visits, the patient in the example may log into the EHR system using the security administrator 220. For example, the user may log by accessing a internet web site using a computer workstation, where the security administrator 220 prompts the user for information, such as a user name and password. Once the user has logged in, the user may access the patient's EHR via the user interface 130. For example, the interface 130 may provide a list of options for the user to select such as, review a patient encounter, review a prescription, access a patient log, access the lifestyle application, receive automatic diagnosis, contact the healthcare provider, etc.

Based on the user instruction via the interface 130, the system may operate one or more system applications. For example, where a user selects to access the lifestyle application 250, the interface will present the lifestyle application 250, as previously described, to the user. Thus, where the patient may enter lifestyle information pertaining to the patient's daily activities, consumption, subjective feelings, etc.

A physician may then access the users EHR via a physician application 260 to review the present status of the EHR. Where the physician notices issues that need to be addressed, the physician my handle the issues accordingly. For example, where the physician determines that a new medication should be prescribed based on the patient symptoms, the physician can thereby prescribe the medication and update the EHR accordingly.

Certain embodiments provide a method for presenting a user with access to an EHR. The method allows a user to access a patient EHR from an EHR system (such as EHR system 100 and/or 200. The method comprises the following steps:

First, a user interface is provided for a user interface via a network, such as the internet. In certain embodiments the user interface may be an interactive web page available on the internet. The user interface allows a user to access an electronic health record system that has at least one patient electronic health record based upon user instruction and user identity.

Next, the user interface prompts a user for user identification. The user interface may use a security administration application to obtain user identification based upon an authentication by the user. For example, the user may be prompted for a user name and password that, once entered, identifies the user. The user identification may provide information such as the user's name, and the type of user, for example, whether the user is a patient or a healthcare provider. Based on the user identification the user may be restricted or limited to access only certain patient EHRs and/or functionality applications.

Next, the interface prompts the user for instructions to retrieve a patient EHR from the EHR system, or an EHR database. For example, the user interface may provide a list of all available patient EHRs that the user has the authority to access. The user may select one or more of the patient EHRs, for example, by clicking a mouse button on the desired patient EHR.

Next, the user interface provides at least one functionality application allowing a user to add information to the patient EHR. For example, the interface may provide for a user to enter lifestyle information via a lifestyle application. Additionally, the interface may provide for a healthcare provider to view the recent lifestyle information entered by a patient via a physician application. In certain embodiments, only certain users will have access to certain functionality applications. For example, the security administrator may restrict access to a lifestyle application so that only user's identified as the patient, and not those identified as healthcare providers, may access the application. Alternatively, the security administrator may restrict access to a physician application such that only the healthcare providers can access the application, for example.

Next, the patient EHR is updated based upon the information entered by the user using the functionality application or applications. The EHR is then saved and/or stored in the EHR system or the EHR database. For example, the patient may enter information into the patient's EHR pertaining to the previous week's diet. Upon exiting the system, the EHR system saves the newly added dietary information as a part of the updated patient EHR.

Thus, the presently described technology provides a more continual treatment for a patient without requiring visits to a healthcare provider. The system described provides patient education and compliance, a sense of duty and ownership to patients, and a way to monitor trends and detect issues that may arise between visits. Using the present technology allows patients to be more pro-active in managing their own health.

The presently described technology provides the ability to capture important information from patient encounters that can be referred to by a patient after an encounter with a healthcare provider. In certain embodiments, patient encounter information is made accessible to the patient over the internet. The present technology extends patient encounters to include relevant post-encounter activities and offers monitoring to ensure that the patient's health improves or remains in a good or stable condition. Accordingly, healthcare providers can provide better care for patients by offering information to patients effectively without the need for additional visits.

Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1) A network for providing patient access to patient electronic health records comprising:
an electronic health records system for creating and storing patient electronic health records, each patient electronic health record being associated with one patient, the electronic health records system comprising
an encounter capture system for capturing information gathered during a patient visit to a healthcare provider and recording the information in a patient electronic health record, and
an electronic health record database for storing at least one patient electronic health record;
a network hub electronically connecting the electronic health records system with at least one computer workstation;
a user interface providing interactive access to patient electronic health records stored in the electronic health record system, permitting patient connected to the network through the network hub may access a the patient electronic health record associated with the patient from a computer workstation via the user interface; and
at least one functionality application allowing a user, through the user interface, to interactively add information to at least one patient electronic health record.
a, wherein the user may add information to the patient electronic health record.

2) The network of claim 1, wherein the network hub is an internet web page, and wherein the patient connects to the network from a computer workstation by accessing the internet web page.

3) The network of claim 1, wherein the at least one functionality applications comprises a security administrator restricting and allowing access to the network.

4) The network of claim 3, wherein the security administrator restricts and allows access to users based on user identification.

5) The network of claim 4, wherein the user provides user identification by providing a user name and password.

6) The network of claim 1, wherein the encounter capture system has an encounter capture application that records the dialogue during a patient encounter with a healthcare provider.

7) The network of claim 1, wherein the at least one functionality applications comprises a lifestyle application prompting a user for information pertaining to the patient's lifestyle.

8) The network of claim 7, wherein the patient lifestyle information includes information pertaining to a patient's diet or exercise.

9) An electronic health records system for capturing, storing and providing access to at least one patient electronic health record comprising:
an encounter capture system for capturing information gathered during a patient visit to a healthcare provider and recording the information in a patient electronic health record;
an electronic health record database for storing at least one patient electronic health record;
a user interface enabling interactive access to the electronic health record database via a computer workstation;
at least one functionality application operable by a user via a the user interface and, on user instruction, the at least one functionality application providing function for modifying at least one patient electronic health record in the electronic health record database; and
a security administrator restricting and allowing access to the electronic health record database from a computer workstation, the security administrator requiring an input from a user via the user interface.

10) The electronic health records system of claim 9, wherein the encounter capture system comprises an encounter capture application that records the dialogue during a patient encounter with a healthcare provider.

11) The electronic health records system of claim 10, wherein the encounter capture system transcribes the recorded dialogue into a readable format.

12) The electronic health records system of claim 9, wherein the at least one functionality application comprises a lifestyle application that, when executed by the user interface, prompts a user for entry of patient lifestyle information, and wherein the lifestyle application adds the entry of patient lifestyle information to the patient electronic health record accessed by the user interface.

13) The electronic health records system of claim 12, further comprising a dietary assistance tool that updates the patient electronic health record based on the patient lifestyle information.

14) The electronic health records system of claim 12, wherein access to the lifestyle application is restricted by the security administrator to users identified as the patient.

15) The electronic health records system of claim 9, wherein the at least one functionality application comprises an automatic diagnosis application that provides an automatic diagnosis based on information in the patient electronic health record.

16) The electronic health records system of claim 9, wherein the at least one functionality application comprises a physician application allowing a user to review information entered into a patient electronic health record, allowing for the user to enter information pertaining to diagnosis, treatment, prescriptions or medical advice, and allowing for the user to prompt the patient for further information.

17) The electronic health records system of claim 16, wherein access to the physician application is restricted by the security administrator to users identified as healthcare providers.

18) A method for providing patient and healthcare provider access to a patient electronic health record via a computer workstation comprising:
providing a user interface accessible via the internet that allows a user to access an electronic health record system comprising at least one patient electronic health record;
prompting a user for user identification;
obtaining a patient electronic health record from the electronic health record system upon user instruction via the user interface;
providing at least one functionality application allowing a user to add information to the patient electronic health record; and
updating the patient electronic health record based upon the information entered by the user using the at least one functionality application and storing the updated patient electronic health record in the electronic health record database.

19) The method of claim 18, further comprising restricting access to patient electronic health records to users identified as the patient associated with the patient electronic health record or a healthcare provider of the patient associated with the patient electronic health record.

20) The method of claim 18, further comprising providing a plurality of functionality applications, wherein access to each functionality application is restricted to use based on the user identification of the user.
